(19) United States
(12) Patent Application Publication
(10) Pub. No.: US 2018/0155231 A1
(43) Pub. Date: Jun. 7, 2018

(54) FLOW STOPPER FOR A BOTTOM DELIVERY MELTER

(71) Applicant: Corning Incorporated, Corning, NY (US)

(72) Inventors: Jason Kenyon, Macedon, NY (US); Glenn Franklin White, Addison, NY (US)

(21) Appl. No.: 15/834,523

(22) Filed: Dec. 7, 2017

Related U.S. Application Data
(60) Provisional application No. 62/431,044, filed on Dec. 7, 2016.

(51) Int. Cl. C03B 5/26

(52) U.S. Cl. CPC C03B 5/26

(57) ABSTRACT

An apparatus for stopping flow from a bottom delivery orifice of a melter includes a plug having a barrel terminating in a tapered nose. The tapered nose occludes the bottom delivery orifice when inserted a sufficient distance into the bottom delivery orifice. The plug is provided with internal cooling. One or more spray tubings are provided externally to the plug to reduce the temperature of any molten material leaking from the bottom delivery orifice while inserting the tapered nose into the bottom delivery orifice.

This application claims the benefit of priority under 35 U.S.C. § 119 of U.S. Provisional Application Ser. No. 62/431,044, filed on Dec. 7, 2016, the content of which is relied upon and incorporated herein by reference in its entirety.

### BACKGROUND

The disclosure relates to periodic melters suitable for melting large batches of material such as glass or glass-ceramic. In one example, a periodic melter includes a furnace tank having a downcomer attached to its bottom to allow bottom delivery of molten glass. The bottom end of the downcomer has an interchangeable tip. Both the tank and downcomer tip are typically made of precious metal. In one periodic melter design, glass flow inside the tank needs to be stopped at a certain level within the tank prior to loading the next batch composition into the tank. However, there are various challenges to stopping glass flow from such a periodic melter, particularly when the melter is operating at a high glass flow rate. One challenge is that the molten glass is quite hot and poses safety concerns for technicians who may be attempting to quickly seal the orifice at the downcomer tip. Another challenge relates to the malleable nature of the precious metal used in making the downcomer tip. Because the tip requires continuous reheating to restart the glass flow, the outside surface of the tip can become irregular, making it difficult to form a reliable seal at the tip orifice with a flat paddle.

### SUMMARY

In some embodiments of the disclosure, an apparatus for stopping flow from a bottom delivery orifice of a melter includes a plug having a barrel and a tapered nose formed at one end of the barrel. The tapered nose is configured to occlude the bottom delivery orifice when inserted a select distance into the bottom delivery orifice. The apparatus further includes a cooling tube disposed inside the barrel and arranged to deliver a stream of cooling fluid to an inner surface of the tapered nose. The apparatus further includes one or more spray tubings disposed externally to the barrel. Each spray tubing can be oriented to deliver a stream of cooling fluid in a direction towards an outer surface of the tapered nose.

In other embodiments of the disclosure, a method of stopping flow from a bottom delivery orifice of a melter includes inserting a tapered nose of a plug into a bottom delivery orifice until the bottom delivery orifice is occluded by the tapered nose. While inserting the tapered nose into the bottom delivery orifice, a first cooling fluid is applied to an inner surface of the tapered nose and a second cooling fluid is applied to molten material leaking from the bottom delivery orifice.

### BRIEF DESCRIPTION OF THE DRAWINGS

The following is a description of the figures in the accompanying drawings. The figures are not necessarily to scale, and certain figures and certain views of the figures may be shown exaggerated in scale or in schematic in the interest of clarity and conciseness.

FIG. 1A is a schematic of a flow stopper apparatus positioned below a melter.

FIG. 1B shows a plug of the flow stopper apparatus of FIG. 1A inserted into a bottom delivery orifice of a melter.

FIG. 2 shows a cross-section of the plug of FIG. 1A with an internal cooling system.

FIG. 3 shows a tapered nose of the plug of FIG. 1A occluding a bottom delivery orifice of a melter.

FIG. 4 shows the plug assembly of FIGS. 1A and 1B with spray tubings connected to a fluid source.

### DETAILED DESCRIPTION

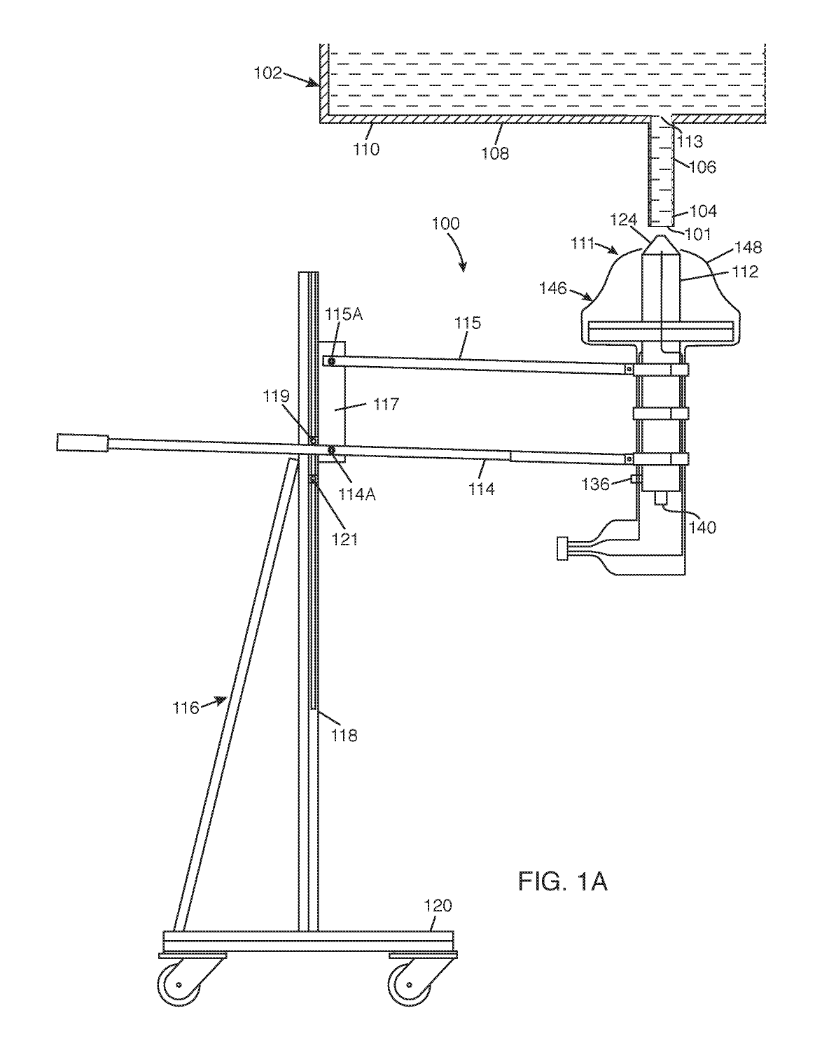

FIG. 1A is schematic of a flow stopper apparatus 100 positioned below a melter 102. The flow stopper apparatus 100 includes a plug assembly 111 having a plug 112 that can be inserted into a bottom delivery orifice 101 of the melter 102 to stop flow of molten material from the bottom delivery orifice 101. In some cases, the molten material may be glass or glass-ceramics. The bottom delivery orifice 101 may be located at the tip 104 of a downcomer 106 attached to the bottom 108 of a furnace tank 110 of the melter 102, as shown in FIG. 1A. If the melter 102 does not include a downcomer 106, the bottom delivery orifice 101 may be located at an opening 113 in the bottom 108 of the furnace tank 110. FIG. 1B shows the plug 112 inserted into the bottom delivery orifice 101, thereby stopping flow of molten material from the bottom delivery orifice 101.

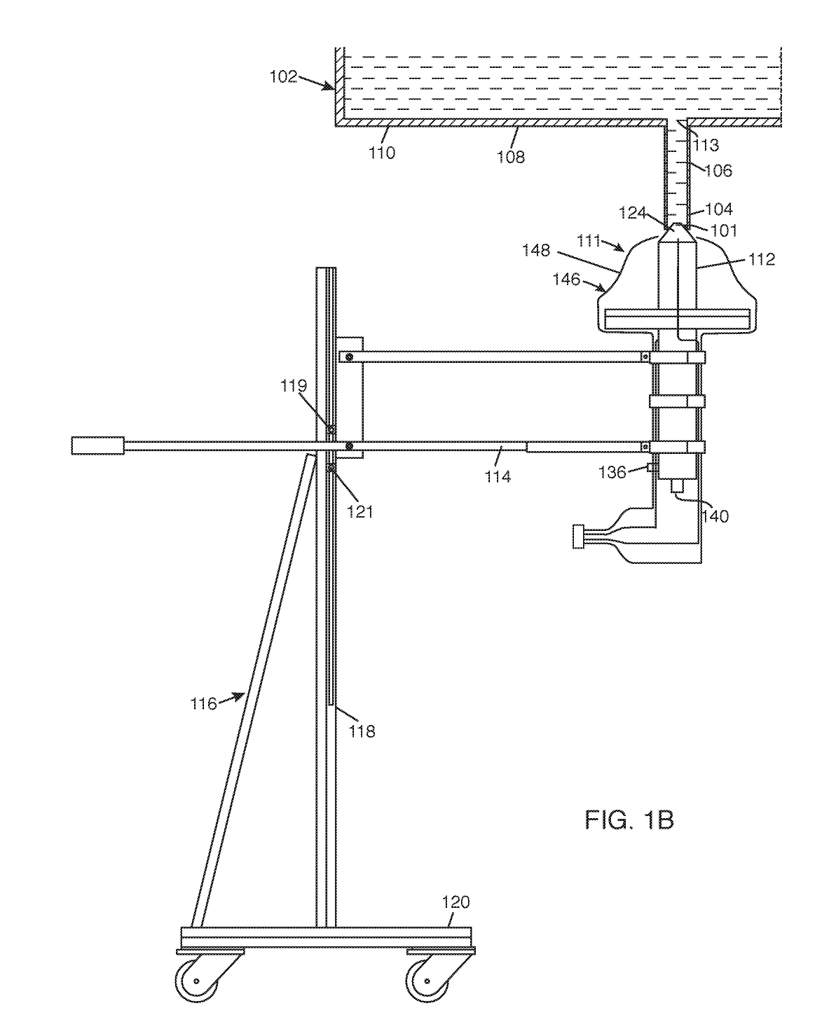

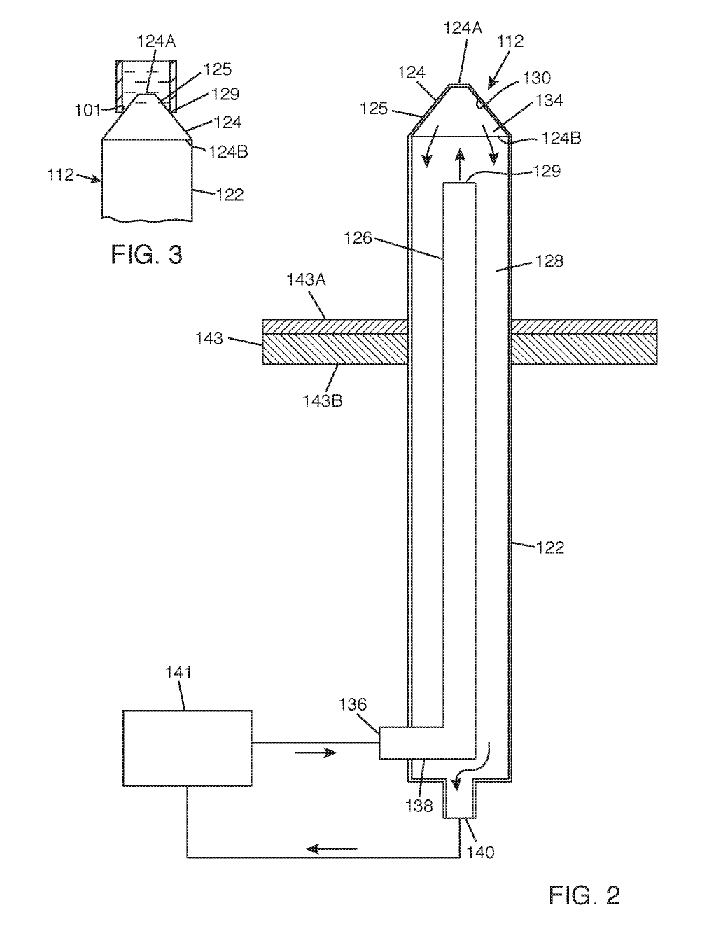

FIG. 2 is a cross-sectional view of the plug 112. As shown in FIG. 2, the plug 112 has a barrel 122 and a tapered nose 124 formed at one end of the barrel 122. Both the barrel 122 and tapered nose 124 may be made of stainless steel or other material that can withstand the temperature of the molten material flowing out of the bottom delivery orifice (101 in FIG. 1A). In some cases, the barrel 122 and tapered nose 124 can be made from precious metal. In one example, the precious metal may be platinum-rhodium (Pt—Rh) alloy, such as Pt—Rh 80/20 weight percent alloy. The tapered nose 124 is the portion of the plug 112 that is inserted into the bottom delivery orifice 101 to stop flow of molten material from the bottom delivery orifice 101. The tapered nose 124 has a conical or frusto-conical shape. In one embodiment, the profile of the tapered nose 124 is selected such that the tapered nose 124 can be inserted into the bottom delivery orifice 101 until the tapered nose 124 occludes the bottom delivery orifice 101. Typically, this means that the tip 124A of the tapered nose 124 will have a smaller diameter than the bottom delivery orifice and the base 124B of the tapered nose 124 will have a larger diameter than the bottom delivery orifice. Thus, as shown in FIG. 3, a circumferential seal 129 will be formed between the bottom delivery orifice 101 and the outer surface 125 of the tapered nose 124 at some point between the tip 124A (small diameter end) and base 124B (large diameter end) of the tapered nose 124.

Returning to FIG. 2, a cooling tube 126 is disposed inside the barrel 122. The diameter of the cooling tube 126 is smaller than the diameter of the barrel 122 such that an annular space 128 is formed between the cooling tube 126 and the barrel 122. The annular space 128 may be symmetrical, i.e., if the cooling tube 126 and barrel 122 are coaxial, or asymmetrical, i.e., if the cooling tube 126 and barrel 112 are not coaxial. The length and position of the cooling tube 126 are such that there is an unobstructed space 134 between the exit end 129 of the cooling tube 126 and the inner surface 130 of the tapered nose 124. Typically, this means that the cooling tube 126 does not extend into the volume within the tapered nose 124. The space 134 above the exit end 129 of the cooling tube forms a continuous flow path with the annular space 128.

The barrel 122 has a side port (or inlet port) 136, which is connected to the inlet end 138 of the cooling tube 126, and a bottom port (or outlet port) 140, which is in communication with the annular space 128. A source 141 of cooling fluid may be connected to the side port 136 to allow delivery of cooling fluid to the cooling tube 126 at a select pressure. The cooling fluid may be water or other suitable cooling fluid, usually a liquid. The pressure at which the cooling fluid is delivered to the cooling tube 126 may be selected such that the cooling fluid emerges from the exit end 129 of the cooling tube 126 as a jet stream directed at the inner surface 130 of the tapered nose 124. This will allow the cooling fluid to concentrate at the inner surface 130 of the tapered nose 124 to more effectively cool the tapered nose 124 from the inside and thereby prevent hot molten material from sticking to the outer surface 125 of the tapered nose 124. Fluid in the space 134 will flow into the annular space 128 and exit the barrel 122 through the bottom port 140. The fluid discharged from the bottom port 140 may be returned to the source 141 of cooling fluid for a closed loop cooling system. The source 141 may include a chiller (not shown separately) for cooling down the returned cooling fluid, which can be fed again to the side port 136.

A plate ring 143 is attached to the exterior of the barrel 122. The plate ring 143 circumscribes a diameter of the barrel 122 and serves as a collector for molten material that flows down the sides of the plug 112 while the plug 112 is placed below the bottom delivery orifice. In one embodiment, the plate ring 143 includes a barrier ring layer 143A stacked on top of a support ring layer 143B. In some cases, the plate ring 143 is attached to the exterior of the barrel 122 by welding, or otherwise securing, the support ring layer 143B to the barrel 122. The barrier ring layer 143A can simply sit on top of the support ring layer 143B, i.e., without any permanent connection to the support ring layer 143B or barrel 122, to facilitate replacement of the barrier ring layer 143A as needed. In one embodiment, the support layer 143 is made of metal, such as stainless steel or other material that is resistant to high temperatures, such as the temperature of the molten material. In some cases, the support layer 143 may be made of the same material as the barrel 122 to facilitate attachment of the support layer 143 to the barrel 122 by welding. The barrier ring layer 143A forms a barrier between the molten material collected on the plate ring 143 and the support ring layer 143B. In one embodiment, the barrier ring layer 143A is made of a thermally insulating material. For glass/glass-ceramic melters, the barrier ring layer 143A may be made of graphite, which is very resistant to glass at high temperatures. The graphite barrier ring layer 143A will protect the metal support ring layer 143B from molten material temperatures that could otherwise cause the metal layer to warp.

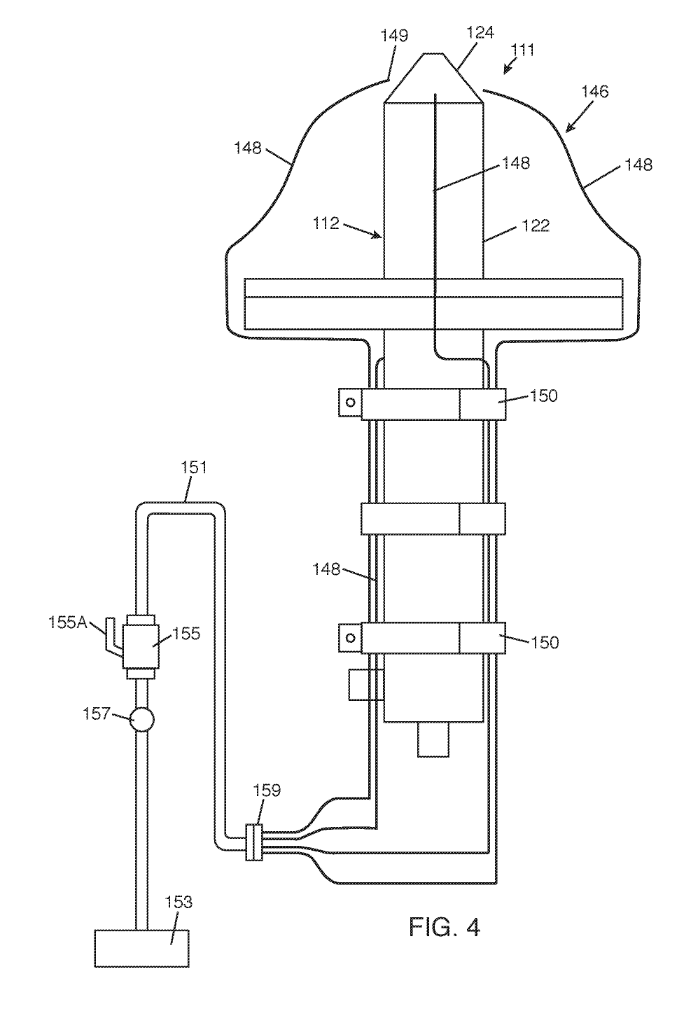

FIG. 4 is a schematic of the plug assembly 111. As shown in FIG. 4, the plug assembly 111 further includes a spray system 146 disposed on the exterior of the plug 112. The spray system 146 includes tubings 148 arranged about the circumference of the plug 112. The spray tubings 148 may be secured to the plug 112 using any suitable method, such as attachment rings or collets 150 mounted to the exterior of the barrel 122 of the plug 112. In the example shown in FIG. 4, the spray system 146 includes four spray tubings 148; however, more or less than four tubings may be used. In one example, the spray tubings 148 are copper tubings and are bendable. The flexibility of the spray tubings 148 allows the spray ends of the tubings to be positioned in any desired orientation relative to the plug 112. In one embodiment, the spray ends 149 of the spray tubings 148 are oriented towards the tapered nose 124 of the plug 112. In this orientation, the tubings 148 can be used to spray fluid on, and rapidly reduce the temperature of, the molten material leaking from the bottom delivery orifice (101 in FIG. 1A) as the tapered nose 124 is inserted into the bottom delivery orifice. Each spray tubing 148 is connected to a source 153 of cooling fluid, which may be water or other liquid. In some cases, the cooling fluid source 153 may be the same as the cooling fluid source (141 in FIG. 2) used for internal cooling of the plug 112. The connection line 151 between the spray tubings 148 and cooling fluid source 153 may include a water actuator 155 and a hydraulic valve 157, such as a needle valve. The water actuator 155 may include a lever 155A that can be operated to allow flow or stop flow through the connection line 151. A quick disconnect adapter 159 may be used to facilitate connection of the spray tubings 148 to the connection line 151.

Returning to FIG. 1A, the flow stopper apparatus 100 further includes a handle 114 having one end coupled to the plug 112. The handle 114 is of sufficient length to allow insertion of the plug 112, or the tapered nose 124 of the plug 112, into the bottom delivery orifice 101 from a safe distance relative to the bottom delivery orifice 101.

The flow stopper apparatus 100 may further include a mobile chassis 116 having a chassis 118 mounted to a rolling base 120. In one embodiment, the handle 114 is attached to the chassis 118, allowing the plug 112 to be mobile and usable with multiple melters. For stability, a linkage 115 may be attached between the plug 112 and the handle 114. The linkage 115 may be generally parallel to the handle 114. Both the linkage 115 and handle 114 may be attached to a bracket 117 on the chassis 118 that is adjustable in height relative to the rolling base 120. For example, the side of the chassis 118 where the bracket 117 is mounted may include a rail to guide motion of the bracket 117 up and down the chassis 118. When the bracket 117 is at the desired height relative to the rolling base 120, the bracket 117 can be locked in place by means of bolts and the like. The joint 115A between the linkage 115 and the bracket 117 and the joint 114A between the handle 114 and the bracket 117 may be pivoting joints that allow adjustment of the height of the plug 112 relative to the bottom delivery orifice 101 using the handle 114. Fulcrum stops 119, 121 may be provided on the chassis 118 to limit pivoting of the handle 114 in the downward and upward directions, respectively. In some cases, the positions of the fulcrum stops 119, 121 along the chassis 118, or the heights of the fulcrum stops 119, 121 relative to the rolling base 120, are adjustable. In some embodiments, the lower fulcrum stop 121 and the height of the bracket 117 may be set such that when the handle 114 abuts the lower fulcrum stop 121, the tapered nose 124 of the plug 112 will be inserted into the bottom delivery orifice 101 and at the position to seal the bottom delivery orifice 101. Also, the upper fulcrum stop 119 may be set such that when the handle 114 abuts the upper fulcrum stop 119, the tapered nose 124 of the plug 112 will be removed from the bottom delivery orifice 101.

The mobile chassis 116 may also support the connection line (151 in FIG. 4), or parts thereof.

When it is desired to stop flow from the bottom delivery orifice 101, the mobile chassis 116 is operated to move the plug 112 below the bottom delivery orifice 101. The spray tubings 148 are connected to the source of cooling fluid (153 in FIG. 4), the side port 136 of the plug 112 is connected to the source of cooling fluid (141 in FIG. 2), and the bottom port 140 of the plug 112 is connected to a discharge line. The handle 114 is then operated to insert the tapered nose 124 of the plug 112 into the bottom delivery orifice 101 until the tapered nose 124 occludes the bottom delivery orifice 101 (see FIG. 3). When the tapered nose 124 occludes the bottom delivery orifice 101, further insertion of the tapered nose 124 into the bottom delivery orifice 101 will generally be impeded, indicating that the plug 112 is at the sealing position. The insertion distance of the tapered nose 124 will generally be dictated by the size of the bottom delivery orifice 101 and the size of the tapered nose 124. While inserting the tapered nose 124 into the bottom delivery orifice 101, the tapered nose 124 is cooled by circulating cooling fluid through the plug 112. Also, the spray system 146 is operated to squirt cooling fluid on the molten material leaking between the bottom delivery orifice 101 and the plug 112. When it is desired to open the bottom delivery orifice 101, the handle 114 may be adjusted to remove the tapered nose 124 from the bottom delivery orifice 101. In some cases, this may be as simple as releasing or pivoting the handle 114 such that the handle 114 abuts the upper fulcrum stop 119. The mobile chassis 116 can then be used to move the plug 112 away from below the bottom delivery orifice 101.

While the invention has been described with respect to a limited number of embodiments, those skilled in the art of, having benefit of this disclosure, will appreciate that other embodiments can be devised which do not depart from the scope of the invention as disclosed herein. Accordingly, the scope of the invention should be limited only by the accompanying claims.

1. An apparatus for stopping flow from a bottom delivery orifice of a melter, comprising:
a plug having a barrel and a tapered nose formed at one end of the barrel, the tapered nose being configured to occlude the bottom delivery orifice when inserted a select distance into the bottom delivery orifice;
a cooling tube disposed inside the barrel and arranged to deliver a stream of first cooling fluid to an inner surface of the tapered nose; and
at least one spray tubing disposed external to the plug and capable of being oriented to deliver a stream of second cooling fluid in a direction towards an outer surface of the tapered nose.

2. The apparatus of claim 1, wherein the tapered nose has a conical or frusto-conical shape.

3. The apparatus of claim 2, wherein a continuous flow path is formed between the cooling tube and the plug for circulating cooling fluid through the plug.

4. The apparatus of claim 3, wherein the continuous flow path comprises an annular space between the cooling tube and the barrel.

5. The apparatus of claim 4, wherein the continuous flow path comprises an unobstructed space between an exit end of the cooling tube and the inner surface of the tapered nose.

6. The apparatus of claim 4, wherein the barrel has an inlet port that is in communication with an inlet end of the cooling tube and an outlet port that is in communication with the annular space.

7. The apparatus of claim 1, wherein the at least one spray tubing is coupled to the barrel.

8. The apparatus of claim 7, further comprising a handle coupled to the barrel.

9. The apparatus of claim 8, further comprising a mobile chassis, wherein the handle is coupled to the mobile chassis to enable mobility of the plug.

10. The apparatus of claim 9, wherein the handle is movably coupled to the mobile chassis, and wherein motion of the handle is configured to adjust a position of the plug relative to the bottom delivery orifice.

11. The apparatus of claim 10, wherein the handle is pivotally coupled to the mobile chassis.

12. The apparatus of claim 11, further comprising at least one stop member on the mobile chassis for limiting pivoting of the handle.

13. The apparatus of claim 1, further comprising a plate ring mounted to an exterior of the barrel for collecting molten material flowing down the sides of the barrel.

14. The apparatus of claim 13, wherein the plate ring comprises a graphite ring layer on a metal ring layer, the graphite ring layer forming a barrier between the molten material and the metal ring layer.

15. A method of stopping flow from a bottom delivery orifice of a melter, comprising:
inserting a tapered nose of a plug into the bottom delivery orifice until the bottom delivery orifice is occluded by the tapered nose; and
while inserting the tapered nose into the bottom delivery orifice, applying a first cooling fluid to an inner surface of the tapered nose and applying a second cooling fluid to molten material leaking from the bottom delivery orifice.

16. The method of claim 15, wherein applying the first cooling fluid to an inner surface of the tapered nose comprises circulating the first cooling fluid through the plug.

17. The method of claim 15, wherein applying the second cooling fluid to molten material leaking from the bottom delivery orifice comprises spraying the second cooling fluid in a direction towards an outer surface of the tapered nose using at least one spray tubing disposed at an exterior of the plug.
